(19) United States
(12) Patent Application Publication
(10) Pub. No.: US 2017/0104827 A1
(43) Pub. Date: Apr. 13, 2017

(54) MULTI-USER WEB SESSION HANDOFF

(71) Applicant: SugarCRM Inc., Cupertino, CA (US)

(72) Inventors: Filipe Guerra, San Jose, CA (US); Vladyslav Kulchytskyy, Nashua, NH (US); Heather Yohn, San Mateo, CA (US)

(21) Appl. No.: 14/881,102

(22) Filed: Oct. 12, 2015

(51) Int. Cl. H04L 29/08

(52) U.S. Cl. CPC H04L 67/14

(57) ABSTRACT

Embodiments of the present invention provide a method, system and computer program product for multi-user Web session handoff. In an embodiment of the invention, a method for multi-user Web session handoff is provided. The method includes establishing a Web session between a primary end user and a Web application over a computer communications network. The method also includes selecting a secondary end user for handoff of the Web session; and establishing a Web session between the selected secondary end user and the Web application over the computer communications network. Finally, the method includes determining a state of the established Web session for the primary end user and restoring the determined state in the established Web session for the secondary end user.

### BACKGROUND OF THE INVENTION

Field of the Invention

The present invention relates to Web session management and more particularly to maintaining session continuity between different end users accessing a Web session.

Description of the Related Art

The advent of the World Wide Web (the “Web”) has created vast opportunities to disseminate information to the public over the global Internet. Initially merely a means of accessing a chain of hyperlinked documents via a Web browser, the technology driving the Web rapidly evolved to include indexing and searching capabilities, and then interactive capabilities so that the a collection of pages published onto the Web could invoke programmatic logic so as to provide a fully driven Web application. In the latter instance, a typical Web application is enabled through the programmatic dynamic determination of a sequence of Web pages permitting user input therein. As such, a typical Web application inherently enjoys state for each session with an end user.

The notion of state in a Web session is not unfamiliar to most as one interacts with a series of Web pages providing input that determines a next Web page to be presented to the end user. Depending upon the nature of the Web application, the duration in which the end user interacts with the Web application depends upon the extent of each presented Web page and the number of Web pages to presented in order to complete the session with the end user. Smaller sessions may be completed in a minimal amount of time. However, larger sessions may be so time consuming so as to present the end user from completing the Web session in one sitting.

In the latter instance, more advanced forms of Web session management permit an end user to persist the state of the Web session for an end user so that the end user may resume the Web session at a later time. Mechanically, Web storage such as a cookie is used to record the state of the Web session along with a session identifier so that upon revisiting the same Web application, the Web application may identify the end user as attempting to restore a partially completed Web session, and may determine the state of the Web session at which point the Web session is to resume. Alternatively, instead of Web storage, the state of the Web session for an end user is stored remotely from the end user in connection with a user identifier of the end user so that when the end user authenticates into the Web application, the Web session may resume.

Importantly, it will be recognized then that the ability to resume a partially completed Web session is limited to the same device as the end user, or the same end user in the circumstance where the state of the Web session is stored in connection with an authenticated end user identifier. However, oftentimes, it would be desirable for multiple end users to participate in a single Web session at different stages of progression. Examples include a process where supervisory intervention is required, or simply where one end user no longer is able to interact with the Web application and thus must delegate the responsibility to complete the Web session to a different end user. Presently, the manner in which a Web session is managed in a Web application does not permit multi-user disruption and resumption of a single Web session.

### BRIEF SUMMARY OF THE INVENTION

Embodiments of the present invention address deficiencies of the art in respect to Web session management and provide a novel and non-obvious method, system and computer program product for multi-user Web session handoff. In an embodiment of the invention, a method for multi-user Web session handoff is provided. The method includes establishing a Web session between a primary end user and a Web application over a computer communications network. The method also includes selecting a secondary end user for handoff of the Web session; and establishing a Web session between the selected secondary end user and the Web application over the computer communications network. Finally, the method includes determining a state of the established Web session for the primary end user and restoring the determined state in the established Web session for the secondary end user.

In one aspect of the embodiment, the primary end user selects the secondary end user in a user interface to the Web application in a list of end users to receive hand off of the Web session. In particular, the list may include only end users determined through presence sensing to be available to receive the hand off. In another aspect of the embodiment, an invitation to the Web session is transmitted to the selected secondary end user with an embedded hyperlink to establish the Web session between the secondary end user and the Web application and to restore the determined state. Optionally, the invitation includes a text field of notes regarding the Web session provided by the primary end user. In even yet another aspect of the embodiment, the invitation is rescindable prior to the selected secondary end user establishing the Web session between the secondary end user and the Web application.

In another embodiment of the invention, a Web session management data processing system is configured for multi-user Web session handoff. The system includes a host computing system that has one or more computers each with memory and at least one processor. The system also includes a Web application hosted by an application server executing in the host computing system and multiple different Web sessions for the Web application managed in the host computing system by the application server. Finally, the system includes a multi-user Web session handoff module hosted by the application server. The module includes program code enabled to establish a Web session between a primary end user and the Web application over a computer communications network, to select a secondary end user for handoff of the Web session, to establish a Web session between the selected secondary end user and the Web application over the computer communications network, and to determine a state of the established Web session for the primary end user and to restore the determined state in the established Web session for the secondary end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for multi-user Web session handoff;

FIG. 2 is a schematic illustration of a Web session management data processing system configured for multi-user Web session handoff; and,

FIG. 3 is a flow chart illustrating a process for multi-user Web session handoff.

### DETAILED DESCRIPTION OF THE INVENTION

Embodiments of the invention provide for multi-user Web session handoff. In accordance with an embodiment of the invention, a Web session is initiated with a primary end user through a computing device of the primary end user by a Web application operating remotely from the computing device over a computer communications network. Prior to the conclusion of the Web session, a secondary end user is identified by the primary end user in a user interface to the Web application and the state of the Web session is persisted. The secondary end user then establishes a communicative link to the Web session and the state of the Web session of the secondary end user is restored to the persisted state of the Web session of the primary end user in lieu of the primary end user completing the Web session.

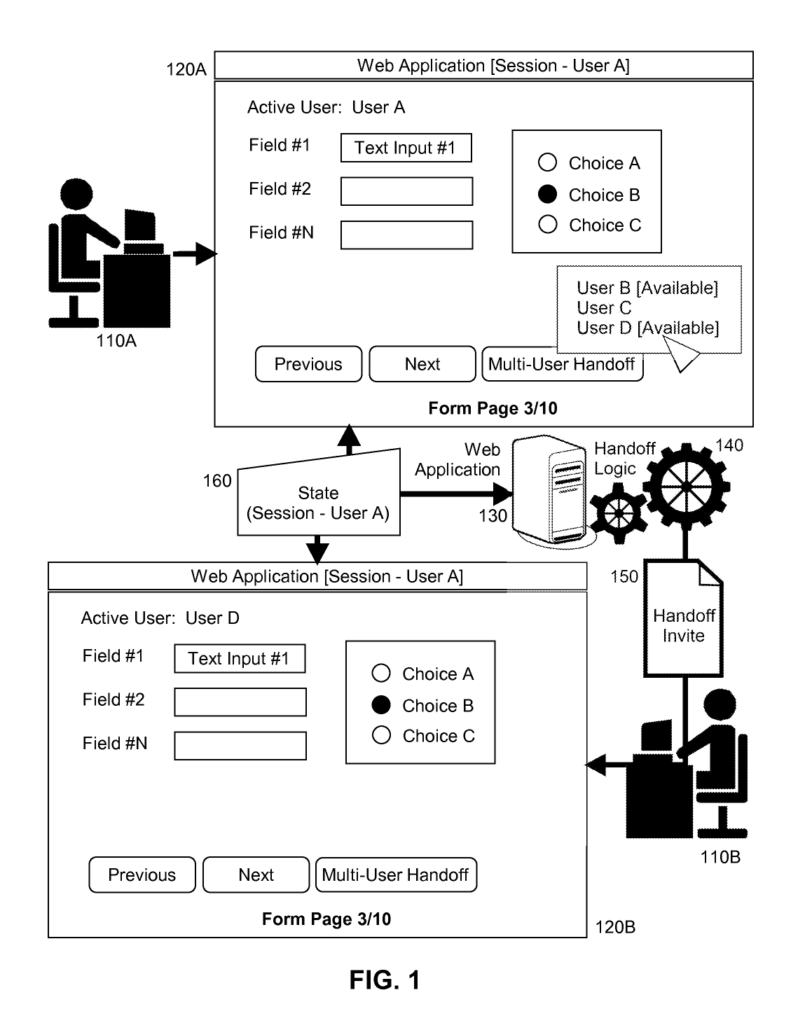

In further illustration, FIG. 1 pictorially shows a process for multi-user Web session handoff. As shown in FIG. 1, a primary end user 110A interacts with a Web application 130 in an established Web session 120A for the Web application. The Web session 120 includes a user interface of multiple different forms presented in a particular sequence according to a particular state 160 of the Web session 120A. In this regard, the state 160 includes not only the input provided by the primary end user 110A to different user interface controls of the user interface of the Web application 130, but also the particular form presented to the primary end user 110A and the previous sequence of forms presented to the primary end user 110A.

During the Web session 120A, the primary end users 110A elects to hand off the Web session 120A to a secondary end user 110. In particular, a user interface control is presented in the user interface of the Web session 120 in which a listing of other end users is presented. Optionally, presence awareness indicates which of the other end users are presently available to receive communications. In response to a selection of one of the other end users as the secondary end user 110B, hand off logic 140 transmits a message 150 to the secondary end user 110B requesting the secondary end user 110B to continue the Web session 120A on behalf of the primary end user 110A. The message may include a hyperlink embedded therein an configured to establish a new Web session 120B for the Web application 130 and to update the new Web session 120B with the state 160 so as effectuate a hand off the of the Web session 120A to the secondary end user 110B.

The process described in connection with FIG. 1 is implemented in a Web session management data processing system. In yet further illustration, FIG. 2 schematically shows a Web session management data processing system configured for multi-user Web session handoff. The system includes a host computing system 210 that includes one or more computers, each with memory and at least one processor. A Web application 230 executes in the host computing system 210 and supports multiple different Web sessions of the Web application 230 with correspondingly different end users over computer communications network 220. Specifically, each of the different end users interacts with the Web application 230 in a Web session through a content browser 260 provided in a respective client computer 250. The Web application 230 maintains each different Web session with each different end user by maintaining a data store of session data 240.

Notably, a multi-user handoff module 300 is coupled to the Web application 230. The module 300 includes program code that when executes in the memory of the host computing system 210, responds to a request by a primary end user to hand off a corresponding Web session of the Web application 230 to a secondary end user, by recording a current state of the corresponding Web session, transmitting an invite in a message to a selected secondary end user, and responding to an acceptance of the invite by the secondary end user by establishing a different Web session of the Web application 230 for the secondary end user and by updating the different Web session with the recorded state of the Web session of the primary end user so as to simulate a handing off of the Web session of the primary end user to the secondary end user.

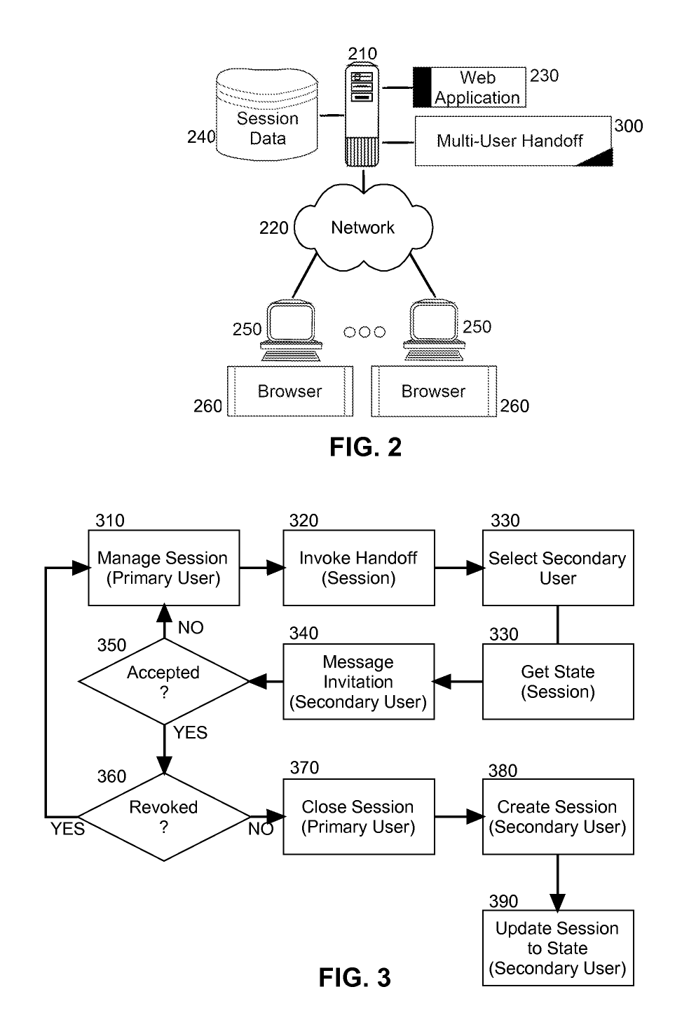

In even yet further illustration of the operation of the multi-user handoff module 300, FIG. 3 is a flow chart illustrating a process for multi-user Web session handoff. Beginning in block 310, a Web session for a Web application is established and maintained with a primary end user in a computing device of the primary end user from over a computer communications network. In block 320, multi-user hand off is invoked for the Web session and in response, a secondary end user is selected from a list of available end users. In block 330, a current state of the Web session is retrieved and an invitation is transmitted to the selected secondary end user.

In decision block 350, it is determined whether or not the invitation is accepted by the secondary end user. If so, in decision block 360 it is further determined whether or not the invitation had been rescinded by the primary end user prior to the secondary end user accepting the invitation. If not, in block 370 the Web session for the primary end user is closed and in block 380 a new Web session is created with the secondary end user. Finally, in block 390 the new Web session is updated to the state indicated by the current state previously retrieved for the primary end user. In this way, hand off of the Web session is effectuated from the primary end user to the secondary end user.

Of note, optionally, multiple different secondary end users can be selected to receive the invitation. In this optional instance, to the extent that one or more of the different secondary end users receive hand off of the Web session subject to acceptance of the invitation and without revocation of the invitation by the primary end user, the state of each of Web session of the secondary end users is monitored. As each Web session of each secondary end user changes, the state of each Web session is synchronized utilizing conflict rules prioritizing synchronization changes of each of the secondary users based upon any of a time of when different changes of state are applied and an identity or role of the secondary end users applying the changes of state.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for multi-user Web session handoff comprising:
establishing a Web session between a primary end user and a Web application over a computer communications network;
selecting a secondary end user for handoff of the Web session;
establishing a Web session between the selected secondary end user and the Web application over the computer communications network; and,
determining a state of the established Web session for the primary end user and restoring the determined state in the established Web session for the secondary end user.

2. The method of claim 1, wherein the primary end user selects the secondary end user in a user interface to the Web application in a list of end users to receive hand off of the Web session.

3. The method of claim 2, wherein the list includes only end users determined through presence sensing to be available to receive the hand off.

4. The method of claim 1, wherein an invitation to the Web session is transmitted to the selected secondary end user with an embedded hyperlink to establish the Web session between the secondary end user and the Web application and to restore the determined state.

5. The method of claim 4, wherein the invitation includes a text field of notes regarding the Web session provided by the primary end user.

6. The method of claim 4, wherein the invitation is rescindable prior to the selected secondary end user establishing the Web session between the secondary end user and the Web application.

7. A Web session management data processing system configured for multi-user Web session handoff, the system comprising:
a host computing system comprising one or more computers each with memory and at least one processor;
a Web application hosted by an application server executing in the host computing system;
a plurality of different Web sessions for the Web application managed in the host computing system by the application server; and,
a multi-user Web session handoff module hosted by the application server, the module comprising program code enabled to establish a Web session between a primary end user and the Web application over a computer communications network, to select a secondary end user for handoff of the Web session, to establish a Web session between the selected secondary end user and the Web application over the computer communications network, and to determine a state of the established Web session for the primary end user and to restore the determined state in the established Web session for the secondary end user.

8. The system of claim 7, wherein the primary end user selects the secondary end user in a user interface to the Web application in a list of end users to receive hand off of the Web session.

9. The system of claim 8, wherein the list includes only end users determined through presence sensing to be available to receive the hand off.

10. The system of claim 7, wherein an invitation to the Web session is transmitted to the selected secondary end user with an embedded hyperlink to establish the Web session between the secondary end user and the Web application and to restore the determined state.

11. The system of claim 10, wherein the invitation includes a text field of notes regarding the Web session provided by the primary end user.

12. The system of claim 10, wherein the invitation is rescindable prior to the selected secondary end user establishing the Web session between the secondary end user and the Web application.

13. A computer program product for multi-user Web session handoff, the computer program product comprising a computer readable storage medium having program instructions embodied therewith, the program instructions executable by a device to cause the device to perform a method comprising:
establishing a Web session between a primary end user and a Web application over a computer communications network;
selecting a secondary end user for handoff of the Web session;
establishing a Web session between the selected secondary end user and the Web application over the computer communications network; and,
determining a state of the established Web session for the primary end user and restoring the determined state in the established Web session for the secondary end user.

14. The computer program product of claim 13, wherein the primary end user selects the secondary end user in a user interface to the Web application in a list of end users to receive hand off of the Web session.

15. The computer program product of claim 14, wherein the list includes only end users determined through presence sensing to be available to receive the hand off.

16. The computer program product of claim 13, wherein an invitation to the Web session is transmitted to the selected secondary end user with an embedded hyperlink to establish the Web session between the secondary end user and the Web application and to restore the determined state.

17. The computer program product of claim 16, wherein the invitation includes a text field of notes regarding the Web session provided by the primary end user.

18. The computer program product of claim 16, wherein the invitation is rescindable prior to the selected secondary end user establishing the Web session between the secondary end user and the Web application.
